(19) United States
(12) Patent Application Publication
(10) Pub. No.: US 2016/0310964 A1
(43) Pub. Date: Oct. 27, 2016

(54) CLAY FLOTATION OF TAILINGS

(71) Applicant: SYNCRUDE CANADA LTD. in trust for the owners of the Syncrude Project as such owners exist now and, Fort McMurray (CA)

(72) Inventors: SIMON YUAN, Edmonton (CA); JAMES LORENTZ, Fort McMurray (CA); YONG (JOE) GU, Edmonton (CA); RON SIMAN, Edmonton (CA)

(21) Appl. No.: 14/943,906

(22) Filed: Nov. 17, 2015

Related U.S. Application Data
(60) Provisional application No. 62/152,450, filed on Apr. 24, 2015.

(51) Int. Cl. B03D 1/02; B03D 3/06; B03D 3/02; B03D 1/10

(52) U.S. Cl. CPC B03D 1/025; B03D 1/10; B03D 3/06; B03D 3/02; B03D 2201/02; B03D 2201/002; B03D 2203/006

(57) ABSTRACT

A process for treating and dewatering tailings comprising fine clay minerals, fine silt minerals and water is provided, comprising treating the tailings with a sufficient amount of a clay surface reagent to selectively modify the surface properties of the fine clay minerals; subjecting the treated tailings to froth flotation to float a portion of the fine clay minerals and form a clay froth layer and froth flotation tails having a reduced fine clay minerals content; and recovering the clay froth layer and subjecting it to dewatering.

### FIELD OF THE INVENTION

The present invention relates generally to a process for dewatering tailings such as oil sands fine tailings and, more particularly, to selectively removing a portion of the fine clay minerals present in the fine tailings by froth flotation using a clay surface reagent such as a cationic collector.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of tailings composed of fine silts (e.g., quartz and feldspar), clays (e.g., kaolinite, illite and smectite) and residual bitumen which have to be contained in a tailings pond. Mineral fractions with a particle diameter less than 44 microns are referred to as “fines.”

Tailings produced during bitumen extraction are typically 50% water and 50% solids by weight. The solids fraction can be further defined as being either fine or coarse solids. Typically, the solid fraction contains 80% coarse and 20% fines by weight. Upon entry into the aqueous tailings storage pond the fines and the coarse material segregate. The majority of the coarse material settles rapidly to form beaches or pond bottom. The fines and a portion of the coarse material settle slowly over a period of years to a typical composition of 35% solids by weight, which composition is sometimes referred to a mature fine tailings or MFT.

Hereinafter, the more general term of fluid fine tailings (FFT) will be used, which encompasses the spectrum of tailings from discharge to final settled state. FFT is generally defined a liquid suspension of oil sands fines in water with a solids content greater than 1% and having less than an undrained shear strength of 5 kPa. The fluid fine tailings behave as a fluid colloidal-like material. The fact that fluid fine tailings behave as a fluid and have very slow consolidation rates limits options to reclaim tailings ponds. A challenge facing the industry remains the removal of water from the fluid fine tailings to increase the solids content well beyond 35 wt % and strengthen the deposits to the point that they can be reclaimed and no longer require containment.

Accordingly, there is a need for an improved method of dewatering tailings, in particular, fine tailings produced during bitumen extraction and fluid fine tailings.

### SUMMARY OF THE INVENTION

The current application is directed to processes for dewatering oil sands tailings, in particular, fine tailings and fluid fine tailings, comprising fine clays, silt and water, by selectively floating a portion of the fine clay minerals, thereby rendering the remaining flotation tailings more amenable to dewatering and consolidation. It was surprisingly discovered that by using the processes of the present invention, one or more of the following benefits may be realized:

(1) Treating fine tailings or fluid fine tailings with a clay surface reagent such as a cationic collector prior to clay flotation may result in effective separation of a portion of the clay minerals (clay froth) from the non-clay minerals (silts) such as quartz and feldspar (flotation tailings). The flotation tailings are easier to process because of the reduced fine clays and may be readily settled.

(2) In addition to a clay surface reagent such as a cationic collector, a frothing agent (frother) such as methyl isobutyl carbinol (MIBC) may be added to make the gas (e.g., air) bubbles more stable and homogeneous and enhance clay recovery in the clay froth.

(3) In some instances, increasing the apparent clay particle sizes by flocculation, coagulation or both of the clay prior to the addition of a clay surface reagent such as a cationic collector enhanced the floatability of the clay minerals.

(4) The froth flotation tails after clay flotation may be more readily dewatered because of the reduced content of fine clay minerals and the relatively coarser tailings remaining in the flotation tailings and can be dewatered by conventional liquid solids separation such as gravity separation, centrifugation, thickening in a thickener, or drainage in a settling basin.

(5) Because the floated clay minerals in the clay froth have been rendered hydrophobic by surface modification by the clay surface reagent such as cationic collector, a large portion of water is quickly drained from the clay froth, while the clay froth is rapidly drying in air (naturally desiccating) due to its high porous structure. The clay froth can also be dewatered using filtration, pressure filtration, belt filtration, etc.

Broadly stated, in one aspect of the present invention, a process of treating and dewatering tailings comprising fine clay minerals, fine silt minerals and water is provided, comprising:
treating the tailings with a sufficient amount of a clay surface reagent to selectively modify the surface properties of the fine clay minerals;
subjecting the treated tailings to froth flotation to float a portion of the modified fine clay minerals to form a clay froth layer and froth flotation tails having a reduced fine clay minerals content; and
recovering the clay froth layer and subjecting it to dewatering.

In one embodiment, the froth flotation tails are further dewatered by subjecting the flotation tailings to liquid solids separation to yield a solids product for reclamation. In one embodiment, the clay froth layer is dewatered by drainage and air drying. In another embodiment, the clay froth layer is dewatered by filtration, pressure filtration, belt filtration and the like.

In one embodiment, the clay surface reagent is a cationic collector selected from the group consisting of dodecylamine (DDA), docecylamine hydrochloride (DDAHCl), docecyl-trimethylammonium chloride (DTAC) and cetyl-trimethylammonium bromide (CTAB). In one embodiment, the dosage of cationic collector is about 650 g/t or greater. In one embodiment, the tailings are diluted with water such as recycle water, prior to treatment with the clay surface reagent such as a cationic collector.

In one embodiment, a frothing agent (frother) such as alcohols (e.g., MIBC), polypropylene glycol ethers, glycol ethers, pine oil, cresol and paraffins, is added in addition to the cationic collector to render the gas bubbles more homogeneous and creates a more stable froth. In one embodiment, a silica depressant such as sodium silicate could be used to depress the flotation of silica (e.g., quartz/feldspar).

In one embodiment, the tailings are treated with a flocculant, a coagulant or both prior to treatment with the clay surface reagent such as a cationic collector.

In one embodiment, the froth flotation tails are treated with a flocculant, a coagulant or both prior to liquid solids separation to yield the solids product. In one embodiment, the liquid solids separation takes place in a gravity separator, a thickener, a centrifuge or a settling basin.

In one embodiment, the tailings are oil sands tailings. In one embodiment, the tailings are fluid fine tailings derived from oil sands operations. In one embodiment, the tailings are fluid fine tailings present in a tailings pond and the clay surface reagent such as a cationic collector is added to the fluid fine tailings in situ.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic of one embodiment of the present invention for dewatering oil sands tailings.

FIG. 2 a schematic of another embodiment of the present invention for dewatering oil sands tailings.

FIG. 3 a schematic of another embodiment of the present invention for dewatering oil sands tailings.

FIG. 4 is a schematic showing fresh tailings streams which can be processed according to the present invention.

FIG. 5 is a schematic of a flotation column useful in the present invention.

FIG. 6 is a bar graph showing the effectiveness of various cationic collectors for clay flotation according to the present invention using fluid fine tailings.

FIG. 7 is a photograph showing the clay froth produced in a Denver flotation cell when the 12.5 wt % FFT was treated with 650 g/tonne dodecylamine.

FIGS. 8A, 8B and 8C are photographs of clay froth produced when FFT having 12.5 wt % solids was treated with 650 g/tonne dodecylamine, subjected to flotation, and the froth placed in a bin, at time zero, after 24 hours, and after removal from the bin, respectively.

FIGS. 9A, 9B and 9C are photographs of clay froth produced when FFT having 12.5 wt % solids was untreated, subjected to flotation, and the froth placed in a bin, at time zero, after 24 hours, and after removal from the bin, respectively.

FIGS. 10A and 10B are photographs showing clay froth produced when FFT having 12.5 wt % solids was treated with 650 g/tonne DDA, subjected to flotation, and the froth placed in a bin, after 48 hours and 72 hours, respectively, of drainage and air drying.

FIG. 11 is a graph showing the total solids recovery in clay froth when FFT samples having 12.5 wt % solids were first treated with the flocculant SNF 3338 at dosages of 0 g/tonne, 50 g/tonne, 100 g/tonne, 500 g/tonne and 800 g/tonne and then treated with dodecylamine at a dosage of 650 g/tonne.

FIGS. 12A, 12B and 12C show the results obtained when treating FFT with 100 g/t SNF 3338 followed by further treatment with 650 g/t DDA at various stages of drainage and drying.

FIG. 13 is a graph showing the solids content in filter cake as a function of time for froth obtained after FFT was treated with 650 g/t DDA and for froth obtained from FFT without chemical treatment.

FIG. 14 is a graph showing filtration rate variation as a function of time for froth obtained after FFT was treated with 650 g/t DDA and for froth obtained from FFT without chemical treatment.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practised without these specific details.

The present invention relates generally to a process for dewatering tailings such as oil sands tailings by treating the tailings with a cationic collector and subjecting the treated tailings to froth flotation. The present invention is particularly useful in treating fine tailings and fluid fine tailings such as mature fine tailings (MFT) present in tailings ponds, where a large portion of the solids are smaller than 44 microns. The major mineralogical components of −10 micron fraction of MFT are silts and clays. The clays are predominantly kaolinite, illite and smectite.

Electrokinetic studies show that both silts and clays are negatively charged under commercial oil sands operation. Both silts and clays are hydrophilic. However, generally, silts such as quartz and feldspar are more negatively charged than clays because of clays being structured as the layered arrangement of silica and alumina. Hence, certain cationic collectors can be used to selectively alter the clay particle surfaces from hydrophilic to hydrophobic, while the silt particles still remain fairly hydrophilic. Thus, based on the different zeta potential and surface properties of silts and clays, the clay particles can be selectively rendered more hydrophobic and can therefore be separated from the silt by froth flotation.

With some tailings, however, the clay particles are particularly small and clay recovery to froth can drop significantly if particles are too small. Thus, in some embodiments, the clay particle size can be enlarged to an optimum size range for clay froth flotation. For example, the clays can be selectively flocculated from the silt by adding anionic polyacrylamides (APAM). Without being bound to theory, due to less negatively charged clays than silt, APAM could be adsorbed on clays through hydrogen bonding among —NH₂-groups in the APAM molecules and —OH-groups on the clay surfaces, with minimal APAM adsorbed on the silts. In one embodiment, a coagulant could also be added or, in the alternative, used instead of a flocculant. Thus, it is possible to selectively flocculate and separate clays from silts by flotation.

As used herein, the term “tailings” means any tailings produced during a mining operation and, in particular, tailings derived from oil sands extraction operations which contain a fines fraction. The term is meant to include fluid fine tailings (FFT) from oil sands tailings ponds and fine tailings from ongoing oil sands extraction operations (for example, bitumen flotation tailings, cyclone overflow, froth treatment tailings, etc.) which may or may not bypass a tailings pond. In one embodiment, the tailings are primarily FFT obtained from oil sands tailings ponds given the significant quantities of such material to reclaim. However, it should be understood that the fine tailings treated according to the process of the present invention are not necessarily obtained from a tailings pond, and may also be obtained from ongoing oil sands extraction operations.

As used herein, the term “flocculation” refers to a process of contact and adhesion whereby the particles of a dispersion form larger-size clusters in the form of flocs or aggregates. As used herein, the term “flocculant” refers to a reagent which promotes flocculation by bridging colloids and other suspended particles in liquids to aggregate, forming a floc. Flocculants useful in the present invention are generally clay-specific, such as various anionic polymers, which may be naturally occurring or synthetic, having relatively high molecular weights. In one embodiment, the dosage of the anionic polymeric flocculant ranges from between about 0 to about 1500 grams per tonne of solids in the tailings.

Suitable natural polymeric flocculants may be polysaccharides such as guar gum, gelatin, alginates, chitosan, and isinglass. Suitable synthetic polymeric flocculants include, but are not limited to, polyacrylamides, for example, a high molecular weight, long-chain modified polyacrylamide (PAM). PAM is a polymer (—CH₂CHCONH₂—)ₙ formed from acrylamide subunits with the following structure:

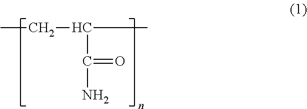

It can be synthesized as a simple linear-chain structure or cross-linked, typically using N,N′-methylenebisacrylamide to form a branched structure. Even though such compounds are often called “polyacrylamide,” many are copolymers of acrylamide and one or more other chemical species, such as an acrylic acid or a salt thereof. The “modified” polymer is thus conferred with a particular ionic character, i.e., changing the anionicity of the PAM. Preferably, the polyacrylamide anionic flocculants are characterized by molecular weights ranging between about 10 to about 24 million, and medium charge density (about 25-30% anionicity).

It will be appreciated by those skilled in the art that various modifications (e.g., branched or straight chain modifications, charge density, molecular weight, dosage) to the flocculant may be contemplated.

As used herein, the term “coagulation” refers to a process of neutralizing repulsive electrostatic charge (often negative) surrounding particles to cause them to collide and agglomerate under the influence of Van der Waals's forces. As used herein, the term “coagulant” refers to a reagent which neutralizes repulsive electrical charges surrounding particles to cause the particles to agglomerate. The term includes organic and inorganic coagulants.

A suitable organic coagulant useful in the present invention includes, but is not limited to, a cationic polymeric coagulant. In one embodiment, the dosage of the cationic polymeric coagulant ranges between about 0 to about 1000 grams per tonne of solids in the tailings. In one embodiment, the cationic polymeric coagulant comprises polydimethyldiallylammonium chloride (or polydiallyldimethylammonium chloride (abbreviated as “polyDADMAC” and having a molecular formula of C₈H₁₆NCl)ₙ). In one embodiment, the polyDADMAC has a molecular weight ranging between about 6,000 to about 1 million, and a high charge density (about 100% cationicity). The monomer DADMAC is formed by reacting two equivalents of allyl chloride with dimethylamine. PolyDADMAC is then synthesized by radical polymerization of DADMAC with an organic peroxide used as a catalyst. Two polymeric structures are possible when polymerizing DADMAC: N-substituted piperidine structure or N-substituted pyrrolidine structure, with the pyrrolidine structure being favored. The polymerization process for polyDADMAC is shown as follows:

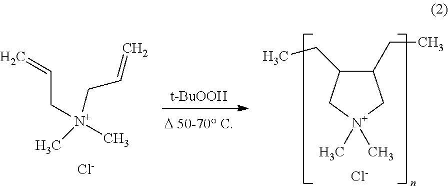

In one embodiment, cationic polymeric coagulants are more effective than inorganic cationic coagulants at the same dosages. However, suitable inorganic cationic coagulants useful in the present invention include, but are not limited to, alum, aluminum chlorohydrate, aluminum sulphate, lime (calcium oxide), slaked lime (calcium hydroxide), calcium chloride, magnesium chloride, iron (II) sulphate (ferrous sulphate), iron (III) chloride (ferric chloride), sodium aluminate, gypsum (calcium sulphate dehydrate), or any combination thereof. In one embodiment, the inorganic coagulants include multivalent cations. As used herein, the term “multivalent” means an element having more than one valence. Valence is defined as the number of valence bonds formed by a given atom. Suitable multivalent inorganic coagulants may comprise divalent or trivalent cations. Divalent cations increase the adhesion of bitumen to clay particles and the coagulation of clay particles, and include, but are not limited to, calcium (Ca²⁺), magnesium (Mg²⁺), and iron (Fe²⁺). Trivalent cations include, but are not limited to, aluminium (Al³⁺), iron (Fe³⁺).

As used herein, the term “clay surface reagent” refers to a reagent which increases the natural hydrophobicity of a mineral surface, in particular, clays, thereby decreasing the mineral's affinity to water. For example, such reagents can adsorb physically onto mineral surfaces that possess active sites having strong negative charge, thereby rendering the mineral surfaces less water loving (hydrophilic) and more water repelling (hydrophobic). A suitable clay surface reagent comprises a cationic collector including dodecylamine (DDA) having a molecular weight of about 185 Da and molecular formula of C₁₂H₂₇N. The other cationic collectors suitable for clay minerals include, but are not limited to, DDAHCl (dodecylamine hydrochloride, MW=221.81); DTAC (dodecyl-trimethylammonium chloride, MW=263.89); and CTAB (cetyl-trimethylammonium bromide, MW=364.45). Other clay surface reagents that may be useful in the present invention include other ammonium surfactants and phosphonium surfactants.

As used herein, a “frothing agent” or “frother” refers to chemicals added to the process which have the ability to change the surface tension of a liquid such that the properties of the sparging bubbles are modified. Frothers may act to stabilize air bubbles so that they will remain well-dispersed in slurry, and will form a stable froth layer that can be removed before the bubbles burst. Ideally the frother should not enhance the flotation of unwanted material and the froth should have the tendency to break down when removed from the flotation apparatus. Frothers suitable for the present invention include alcohols (e.g., MIBC), polypropylene glycol ethers, glycol ethers, pine oil, cresol and paraffins.

As used herein, a “depressant” refers to a chemical that may depress quartz/feldspar and enhance the hydrophobicity difference between the clays and the quartz/feldspar, and hence increase the clay flotation selectivity. The typical silica depressant is sodium silicate (commonly referred to as “water glass”). A depressant may include pH modifying agents that have a strong impact on oxide mineral surface charges, and hence, on the adsorption of collectors and selectivity between silica and clays. For example, at pH 4 using a cationic collector such as DDA, clays have the maximum recovery while silica has the lowest recovery. Thus, pH modifiers also function as depressants to some extent.

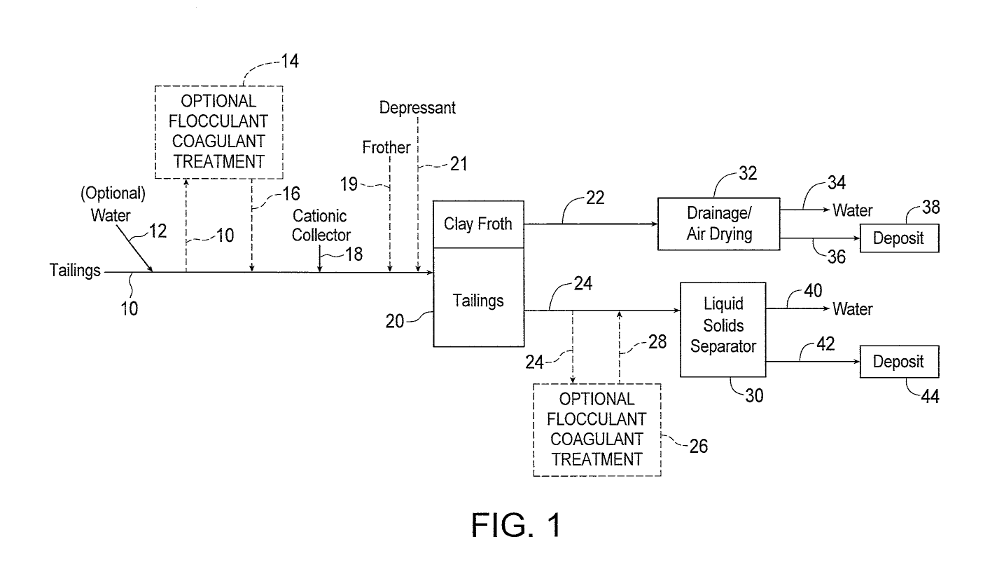

As previously mentioned, the present invention relates generally to a process for improving the dewatering of tailings such as oil sands tailings. With reference to FIG. 1, in one embodiment, tailings 10 comprising silts such as quartz and feldspar, clays and water may be optionally diluted with water 12 to form a tailings feed having a preferred solids content of about 5 wt % to about 35 wt. %, preferably 10 wt. % to 20 wt. %. In one embodiment, the tailings 10 can be optionally treated with a flocculant, a coagulant or both in a mixer 14, such as a dynamic mixer, T mixer, static mixer or continuous-flow stirred-tank reactor, to selectively increase the clay particle size. In one embodiment, the flocculant is APAM. In one embodiment, the coagulant is polyaluminum chloride. Mixing is conducted for a sufficient duration in order to allow the tailings and additives to combine properly and to ensure the efficiency of the additives.

The flocculant and/or coagulant treated tailings 16 (or untreated tailings 10) are treated with a cationic collector 18 which is selective for clay minerals. In one embodiment, a frother 19 is optionally added in addition to cationic collector 18. In one embodiment, a silica depressant 21 such as sodium silicate to depress the flotation of silica. The cationic collector treated tailings are then subjected to froth flotation in a flotation cell or column 20. Air or carbon dioxide can be used as the gas phase for flotation. In one embodiment, CO₂ is used, as solids consolidation in the froth is improved due to easier collapse of CO₂ bubbles.

The clay froth 22 formed as a layer during flotation is then subjected to natural drainage and air drying in a containment cell 32. In one embodiment, the clay froth 22 has a solids content of about 12.5 wt. % and after about twenty-four hours of natural drainage and evaporation, the solids content in the clay froth was greater than 50 wt. %. It is understood that other dewatering technologies known in the art can be used to dewater the clay froth, for example, pressure filtration, belt filtration and centrifugation. The dewatered clay froth 36 can then be deposited in deposition site 38 where further dewatering can occur. The water 34 produced during drainage can be used as recycle water.

The flotation tailings 24 can be optionally treated with a flocculant, coagulant or both in mixer 26, such as a dynamic mixer, T mixer, static mixer or continuous-flow stirred-tank reactor. Mixing is conducted for a sufficient duration in order to allow the flotation tailings and additives to combine properly and to ensure the efficiency of the additives. The flocculant/coagulant treated flotation tailings 28 (or untreated flotation tailings 24) can be subjected to liquid solids separation in a separator 30, which separator can be a pond, thickener, a centrifuge, a hydrocyclone, etc. In one embodiment, the dewatered non-clay tailings 42 can be directly deposited in a deposition site 44 and the water 40 can be reused as recycle water.

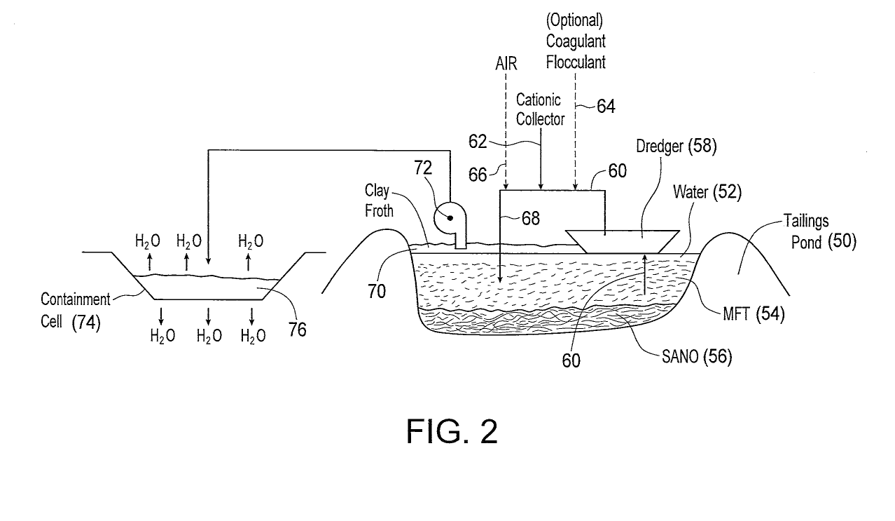

With reference now to FIG. 2, another embodiment of the present process treats tailings in situ in tailings ponds and the like. Generally, after several years, an oil sands tailings pond 50 comprises three layers; a water layer 52; a fluid fine tailings layer 54, which is sometimes referred to as mature fine tailings or MFT, and a coarse sand layer 56. A dredger 58 is used to withdraw a stream of fluid fine tailings 60 and to add a cationic collector 62 which is selective for clay minerals to stream 60. Optionally, a flocculant, a coagulant or both (64) can be added to stream 60 prior to the addition of the cationic collector 62. Further, air 66 or other gas (e.g., CO₂) can be added to stream 60 after the addition of the cationic collector to aid in the flotation of the clay minerals. The treated tailings 68 are then placed back into the tailings pond 50 where clay froth will start to rise to form a clay froth layer 70. The clay froth 70 can be pumped from the tailings pond 50 using pump 72 into a containment cell 74, where drainage will occur as well as evaporation to consolidate the clays for further disposal. It is understood that other mechanical devices can be used to remove the clay froth 70 from the tailings pond 50 such as a froth skimmer, dredger and the like. The flotation tailings remaining in the tailings pond 50 are now more amenable to consolidation due to the reduced amounts of fine clays therein.

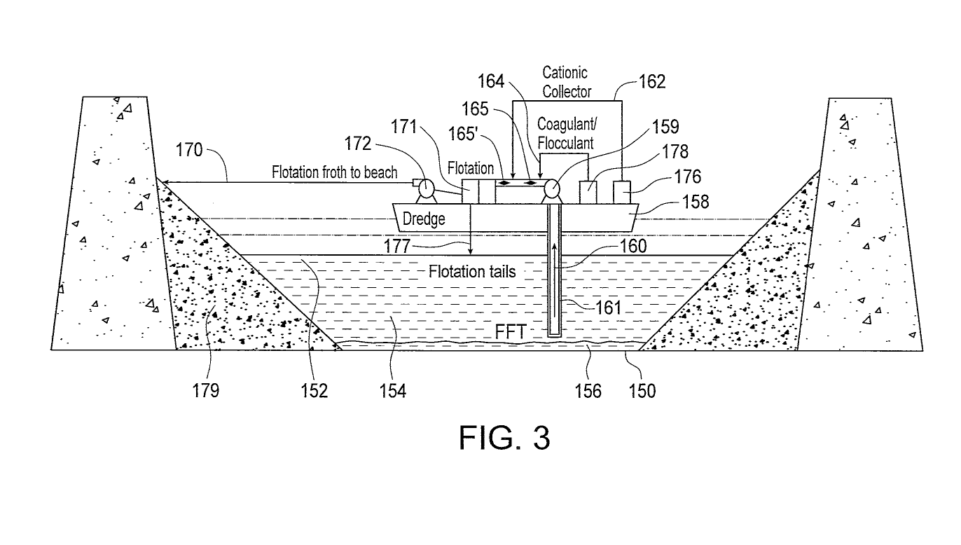

FIG. 3 shows a flow sheet of another embodiment of the present invention. In this embodiment, fluid fine tailings (FFT) 160 can be dredged from existing tailings ponds 150 comprising a water layer 152; a fluid fine tailings layer 154 and a coarse sand layer 156, using dredging equipment 158 known in the art by pumping the FFT 160 through pipe 161 via pump 159. To the dredged FFT 160 can optionally be added a coagulant, a flocculant, or both, which additive 164 may be mixed in-line with FFT 160 using at least one in-line static or dynamic mixer 165. Coagulant and/or flocculant can be pre-prepared and stored in at least one tank 176. In the alternative, coagulant/flocculant can be prepared in specialty units (not shown) located on the dredging equipment 158 itself. Cationic collector 162 can be added to the optionally coagulant/flocculant-treated FFT and the collector-treated FFT can be mixed in-line using at least one in-line static or dynamic mixer 165′.

The thus-treated FFT can then be subjected to flotation in at least one flotation cell, which comprises part of the dredging equipment 158, where a clay froth 170 is formed and flotation tails 177. Flotation clay froth 170 can be deposited on the tailings pond beach 179, which is comprised primarily of coarse beach sand, where it can be quickly dried. The flotation tails 144 are disposed into tailings pond 150.

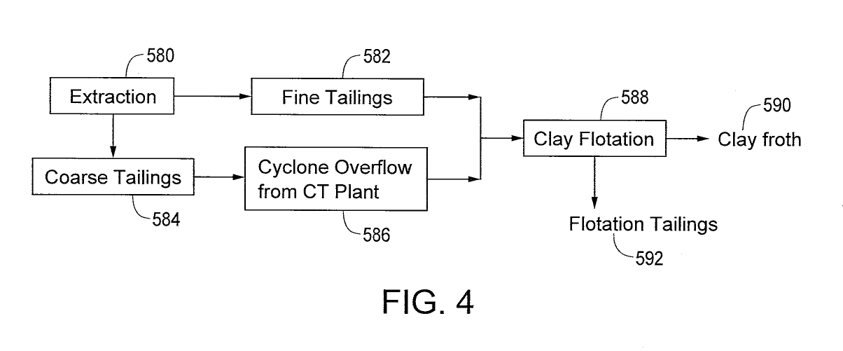

FIG. 4 illustrates another source of fine tailings that can be used in the present invention. Bitumen is extracted from mined oil sand by forming a slurry with warm/hot water, conditioning the slurry (for example, in a hydrotransport pipeline) to release the bitumen and then subjecting the slurry to gravity separation in a primary separation vessel (PSV) wherein the bitumen floats to the top of the PSV and coarse tailings settle on the bottom of the PSV. This process is referred to generally in FIG. 4 as extraction 580. In addition to the bitumen froth and coarse tailings layer, a fine tailings layer, or middlings, is formed therebetween (referred to generally in FIG. 4 as fine tailings 582). This middlings layer is primarily comprised of silts, clays and water.

The coarse tailings 584 formed during extraction are often subjected to hydrocycloning to concentrate the coarse tailings for use in a tailings reclamation process referred to as composite tails or CT. The overflow 586 from the hydrocyclones in the CT plant 586 comprises silts, clays and water. The cyclone overflow 586 can be combined with fine tailings or middlings 582 and this mixture of fresh tailings can then be subjected to froth flotation 588, as described above, to produce a clay froth stream 590 and froth flotation tails 592, each of which are readily dewatered according to the present invention.

Exemplary embodiments of the present invention are described in the following Examples, which are set forth to aid in the understanding of the invention, and should not be construed to limit in any way the scope of the invention as defined in the claims which follow thereafter. In the following Examples, the liquid solids separation process involves the use of a filter press. It is understood, however, that other liquid solids separation processes can be used.

### EXAMPLE 1

In the present example, Mature Fine Tailings or MFT were used as the tailings source. The mineral composition of MFT of different size fractions is shown in Table 1.

TABLE 1

| | | Content, wt. % | |
|---|---|---|---|
| Mineral | Mineral | −10 μm | −0.3 μm |
| Group | Type | fraction | fraction |
| | Quartz | 27.9 ± 0.5 | 8.5 ± 0.6 |
| Carbonates | Ankerite | 0.6 ± 0.2 | 0.3 ± 0.2 |
| | Calcite | 1.8 ± 0.6 | 2.1 ± 1.1 |
| | Siderite | 5.2 ± 0.3 | 1.1 ± 0.4 |
| Feldspars | K-spar | 1.3 ± 0.4 | 1.9 ± 0.5 |
| | Plagioclase | 0.8 ± 0.3 | 0.7 ± 0.4 |
| | Pyrite | 0.4 ± 0.1 | 0.2 ± 0.1 |
| | Anatase | 1.0 ± 0.2 | 1.3 ± 0.2 |
| | Rutile | 0.6 ± 0.2 | 0.8 ± 0.3 |
| Clay | Chlorite | 1.8 ± 0.5 | 2.2 ± 0.6 |
| minerals | Kaolinite (90)-smectite* | n.a. | 7.5 ± 0.7 |
| | Kaolinite | 41 ± 0.7 | 41.6 ± 0.7 |
| | Illite (77)-smectite | 3.9 ± 0.7 | 16.7 ± 0.7 |
| | Illite | 14.0 ± 0.7 | 15.8 ± 0.7 |
| | Estimated total surface area | 22 ± 1 | 86 ± 4 |
| | (m²/g) | | |

*i.e., 90% kaolinite and 10% smectite

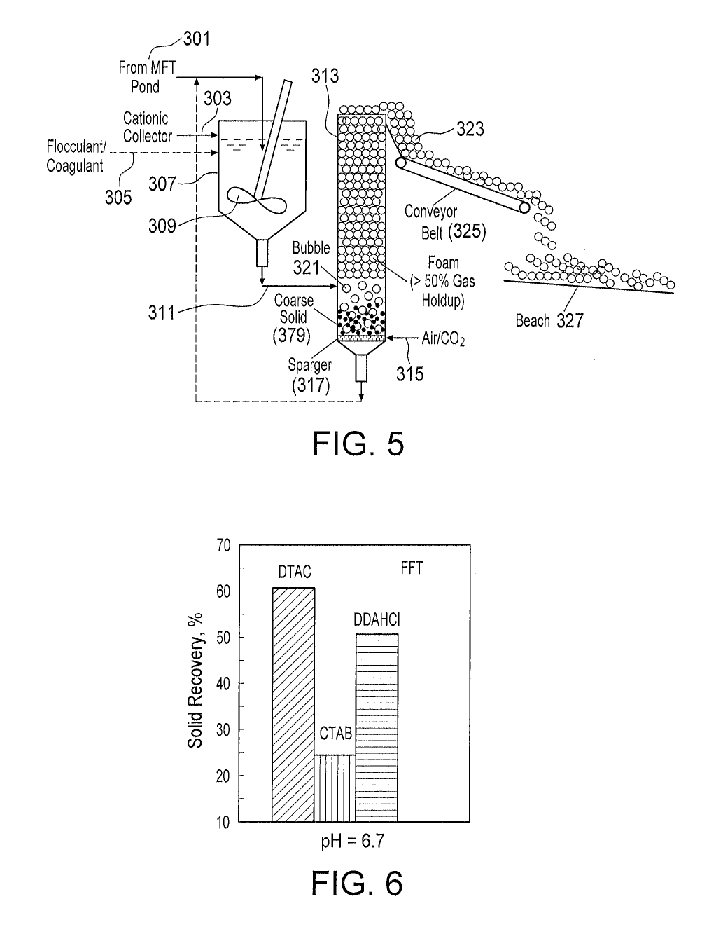

One flotation apparatus useful in the present invention is shown in FIG. 5. MFT 301 from a tailings pond is added to a mixer 307 having a stirrer 309. Optionally, the MFT 301 can be diluted with process water. Cationic collector 303 is added to the MFT 301 and, optionally, a coagulant, a flocculant, or both (305) is also added to mixer 307. Treated tailings 311 are then subjected to column flotation in flotation column 313 comprising sparger 317 where air, CO₂ or other gas 315 is added to the flotation column 313. Bubbles 321 are formed which will selectively carry the clay particles to the top of flotation column 313 as a clay froth 323. The clay froth can then be transported by a conveyer belt 325 or the like to deposition site 327 (e.g., beach), whether rapid dewatering of the clay froth occurs via drainage and evaporation. The froth flotation tails 379 are primarily comprised of the coarser solids and can be treated separately. It is understood that any flotation apparatus known in the art can be used, for example, flotation cells, flotation tanks, etc.

FIG. 6 is a bar graft showing the effectiveness of three cationic collectors on solids (clay) recovery from MFT in the flotation froth. The MFT was diluted to give a feed of 12.5 wt % solids. DTAC, CTAB and DDACl were tested at a flotation pH of 6.7. It can be seen in FIG. 6 that all three cationic collectors worked to some degree; however, DTAC worked the best, giving a solids recovery of over 60%. Within 24 hours, the solids content of the DTAC froth increased from about 12% to more than 30% solids.

In one test, a flocculant, an anionic polyacrylamide or APAM, was added to the diluted MFT at a dosage of 50 g/t or 500 g/t. The cationic collector was 650 g/t DDA. It was found that adding APAM prior to flotation increased the solids content in the froth to 15-16% from about 12% in the feed. The solids content in the froth quickly increased to over 50%, after natural drainage and evaporation for 24 hr. In another test, it was shown that using CO₂ resulted in a froth with a higher solids content (<18-19%) than when using air (up to 15-16%).

### EXAMPLE 2

In this example, 2 L of fluid fine tailings feed having a total solids content of 12.5 wt % were either treated with 650 g/tonne dodecylamine (DDA) (conditioning/mixing time of 2 minutes) or left untreated. The respective treated and untreated tailings were then subjected to flotation for 15 minutes in a laboratory froth flotation cell (Denver flotation cell). A clay froth layer was floated to the top of the flotation device and a tails fraction formed at the bottom of the flotation device. The respective clay froths were placed in a bin and left to drain and air dry for 24 hours.

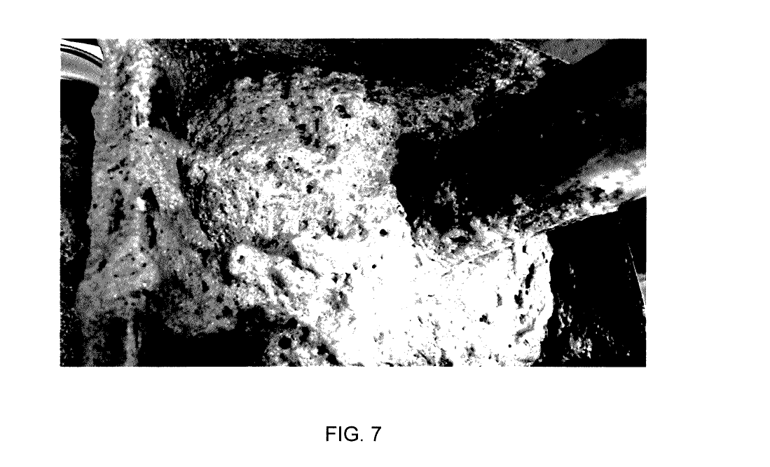

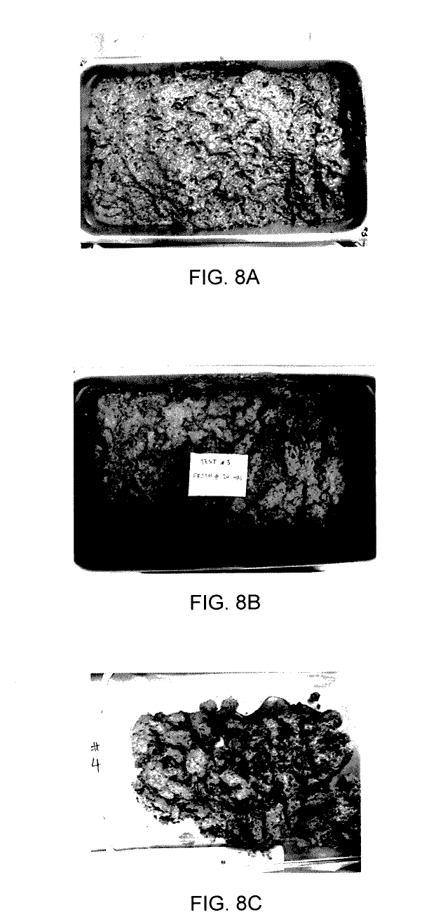

FIG. 7 is a photograph showing the clay froth produced in a Denver flotation cell when the 12.5 wt % FFT was treated with 650 g/tonne dodecylamine. FIGS. 8A, 8B and 8C show the results for the tailings treated with DDA. In particular, FIG. 8A is a photograph showing the clay froth that was floated to the top of the flotation cell. It can be seen that the fresh clay flotation froth contained microbubbles and comprised about 11-13 wt % solids. The flotation tails comprised about 3 wt % solids. The fresh froth represented about 50 wt % solids recovery. FIG. 8B is a photograph showing the clay froth after air drying and drainage at ambient temperature for 24 hours. The water drained to the bottom of the bin while the froth still floated on the liquid due to its hydrophobic nature and it can be seen that the froth is fairly dry already. The 24 hour froth was then removed from the top of the drained water and, as can be seen in FIG. 8C, was fairly dry. The drained/dried froth contained from about 35-55 wt % solids.

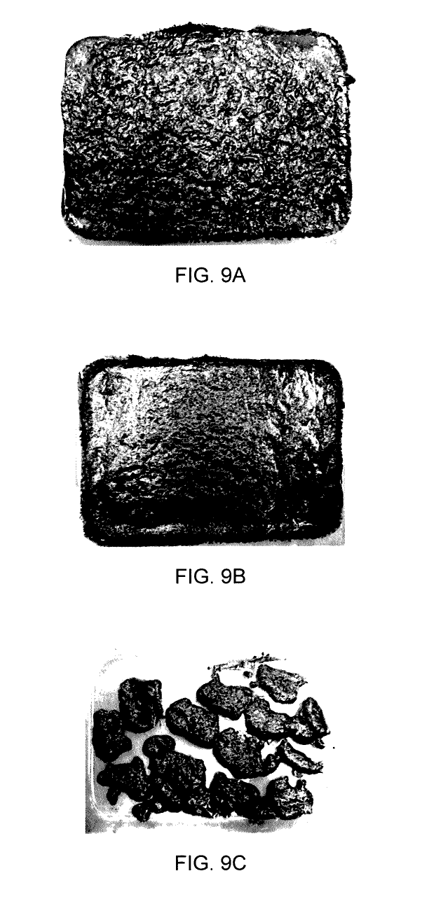

FIGS. 9A, 9B and 9C show the results for the untreated tailings. FIG. 9A is a photograph showing that significantly less froth floated to the top of the flotation cell. The fresh froth represented only about 20 wt % recovery of solids. The froth flotation tails comprised about 10.5 wt % solids. FIG. 9B is a photograph showing the clay froth after air drying and drainage at ambient temperature for 24 hours. It can be seen that the froth is still watery with very little water draining to the bottom of the bin. The froth was removed and, as can be seen in FIG. 9C, was still watery.

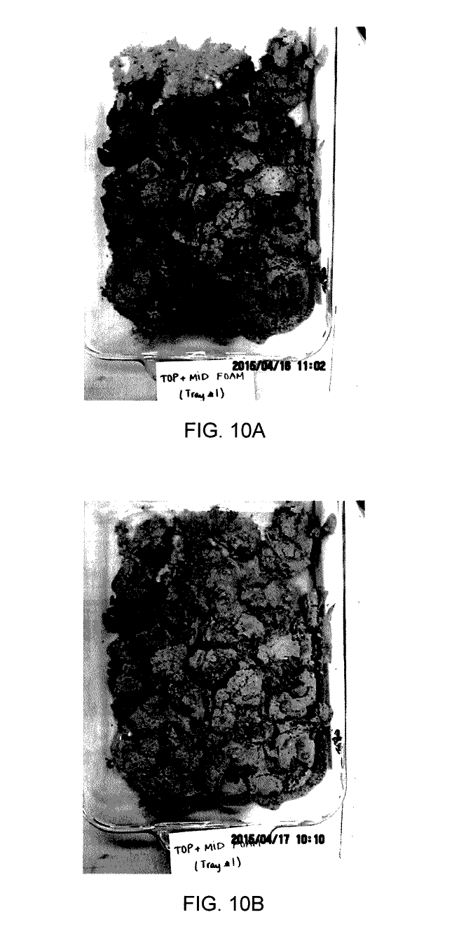

FIGS. 10A and 10B are photographs showing clay froths obtained from FFT treated with 650 g/tonne DDA and subjected to flotation as described above, after 48 hours and 72 hours, respectively, of drainage and air drying. As can be seen in FIG. 10A, after 48 hours, the clay continued to dry quickly and at this point contained about 55-85 wt % solids. FIG. 10B shows that, after 72 hours, the clay froth is almost completely dry and comprised greater than 95 wt % solids.

### EXAMPLE 3

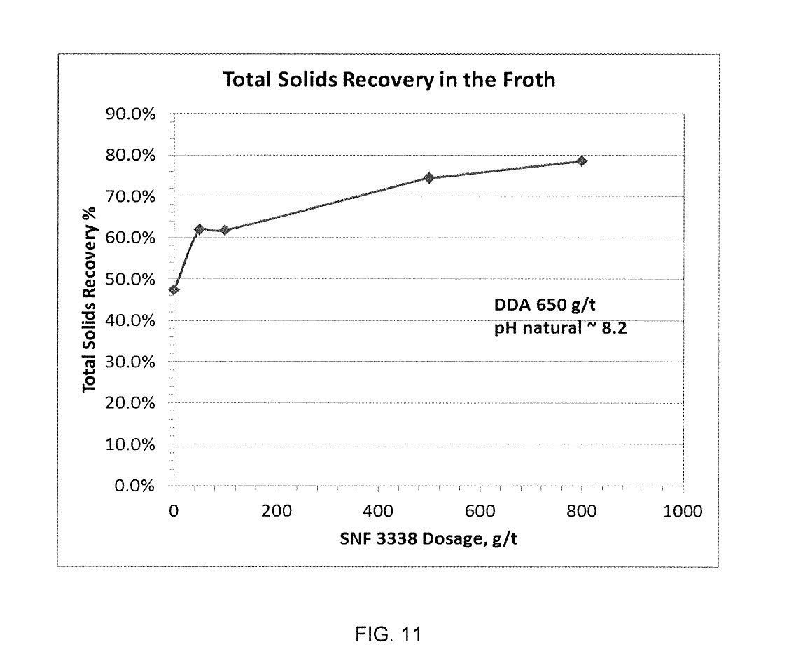

Experiments were done to determine the effect of adding a flocculant that has a relatively high affinity for clay particles prior to treatment with a clay surface reagent such as DDA. FFT samples having 12.5 wt % solids were first treated/mixed with a high molecular weight, anionic polyacrylamide flocculant, which is commercially available under the name SNF 3338, at dosages of 0 g/tonne, 50 g/tonne, 100 g/tonne, 500 g/tonne and 800 g/tonne, and mixed for about 0.5 minutes. The cationic collector DDA was then added at a dosage of 650 g/tonne and the tailings were further conditioned/mixed for 2 minutes. The thus-treated tailings were then subjected to 15 minutes flotation in a Denver flotation cell and the clay froth was retrieved. The total solids recovery in the clay froths was then determined. The results can be seen in FIG. 11. It can be seen in FIG. 11 that at the highest dosage of polymeric flocculant (800 g/t), the total solids recovered in the clay froth increased from about 47 wt % (with no flocculant) to almost 80 wt %. Even when using very small amounts of polymeric flocculant (50-100 g/t), the clay/solids recovery is increased by more than 10%. Without being bound by theory, it is believed that the addition of a clay-specific flocculant causes the clay particles to form larger flocs. These flocs can then be rendered hydrophobic by adding a clay surface reagent such as a cationic clay collector, which then allows the clay flocs to separate from the silt/sand and float, while the silt/sand sinks to the bottom of the flotation cell as flotation tails.

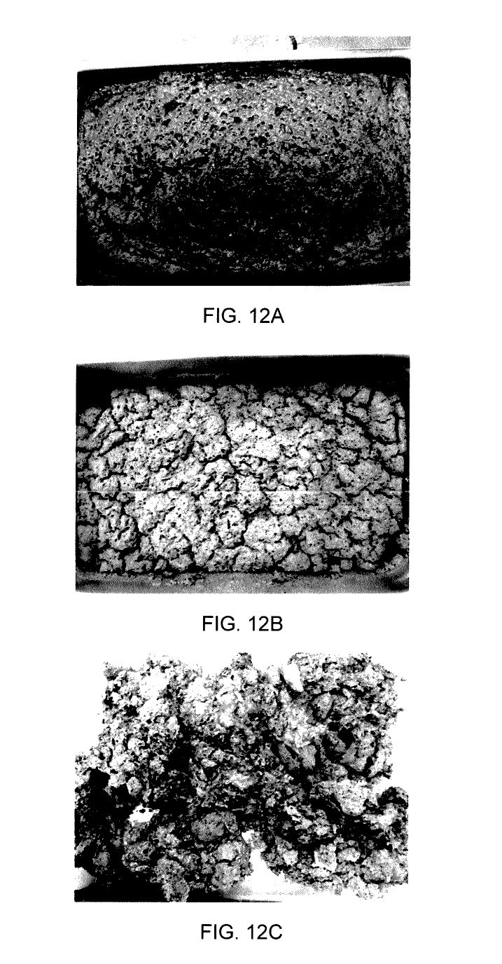

FIGS. 12A, 12B and 12C show the results obtained when treating FFT with 100 g/t SNF 3338 followed by further treatment with 650 g/t DDA. In particular, FIG. 12A is a photograph showing the clay froth that was floated to the top of the flotation cell and placed in a bin. It can be seen that the fresh clay flotation froth is fairly thick and also contains microbubbles. The fresh froth represented about 60 wt % solids recovery. FIG. 12B is a photograph showing the clay froth after air drying and drainage at ambient temperature for 24 hours. The water drained to the bottom of the bin while the froth still floated on the liquid due to its hydrophobic nature and it can be seen that the froth is fairly dry already. The 24 hour froth was then removed from the top of the drained water and, as can be seen in FIG. 12C, was fairly dry.

### EXAMPLE 4

A clay froth was generated by 15 minutes of flotation in a Denver flotation cell after mixing FFT having 15 wt % solids with 500 g/t SNF 3338 for 0.5 minutes and then 650 g/t DDA for 2 minutes. A portion of the flotation froth was then placed into an Ertelalsop LAB-43TJ filter having a filter cylinder ID of 17.5 cm and a filter media comprising Die 81. The filter pressure was gradually increased from 20 psi up to 80 psi and maintained up to 1.5 hrs. Air bubbles in the froth collapsed under pressure with a huge volume change from froth to filter cake. The filter cake was very dry with a solids content of 75.9% measured by oven and 78.9% checked by a moisture analyzer. The results can be seen in Table 2 below.

TABLE 2

| Product | Wet wt. g | Solids % | Solids Recovery % |
|---|---|---|---|
| Cake | 97 | 75.86% | 99.16% |
| Filtrate | 190 | 0.33% | 0.84% |
| Sum | 287 | 25.92% | 100.00% |

Thus, it can be seen that the filter cake solids content is well above the FFT plastic limit of about 70% solids. Over 99% of the clay was recovered using filtration with only a small amount of solids (0.84%) being found in the filtrate. It is understood that the filtrate can be reused in the overall oil sands extraction process. Once again, the froth filtration results showed that enlarging the clay particle sizes by adding a flocculant first, followed by addition of a clay surface reagent such as DDA, resulted in a rapidly dewatering froth. Further, the flotation froth was shown to contain mainly hydrophobic clays and relatively less bitumen. Finally, approximately 74% of the FFT solids were recovered in the flotation froth.

For comparison, froth was generated after 15 minutes flotation of 15% solids FFT with no chemicals added to the 2-L flotation cell. The froth was then poured into a filter and the filter pressure was gradually increased from 20 psi up to 80 psi and maintained up to 1.5 hrs as described above. The results are shown in Table 3 below.

TABLE 3

| Product | Wt., g | Solids % | Recovery % |
|---|---|---|---|
| Cake | 298 | 31.78% | 99.48% |
| Filtrate | 250 | 0.20% | 0.52% |
| Sum | 548 | 17.38% | 100.00% |

It can be seen from the results in Table 3 that the percent solids in the filter cake was only 31.78%. Further, the flotation froth was found to contain mainly bitumen and entrained solids associated with the bitumen as opposed to selectively floated clay. Finally, only approximately 28% of the total FFT solids were recovered in the flotation froth.

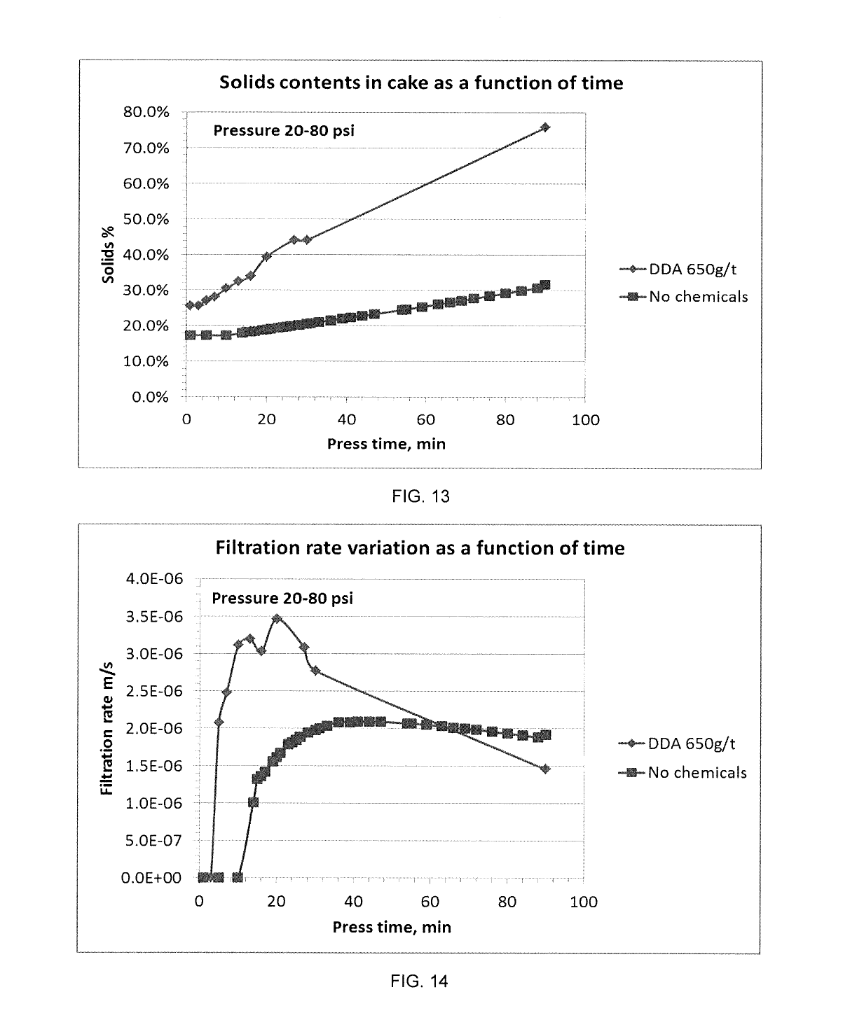

FIG. 13 is a graph showing the solids content in filter cake as a function of time for filter cake from froth obtained after FFT was treated with 500 g/t SNF 3338 followed by treatment with 650 g/t DDA and for filter cake from froth obtained from FFT without chemical treatment. It can be seen that the filter cake obtained from froth obtained from DDA-treated FFT was much denser than that obtained from froth from untreated FFT.

FIG. 14 is a graph showing filtration rate variation as a function of time for froth obtained after FFT was treated with 650 g/t DDA and for froth obtained from FFT without chemical treatment. It can be seen that treatment of the FFT prior to froth flotation resulted in an enhanced froth filtration rate.

The scope of the claims should not be limited by the preferred embodiments set forth in the examples, but should be given the broadest interpretation consistent with the description as a whole.

1. A process for treating and dewatering tailings comprising fine clay minerals, fine silt minerals and water, comprising:
(a) treating the tailings with a sufficient amount of a clay surface reagent to selectively modify the surface properties of the fine clay minerals;
(b) subjecting the treated tailings to froth flotation to float a portion of the fine clay minerals and form a clay froth layer and froth flotation tails having a reduced fine clay minerals content; and
(c) recovering the clay froth layer and subjecting it to dewatering.

2. The process as claimed in claim 1, wherein the clay froth layer is dewatered by drainage and air drying.

3. The process as claimed in claim 1, further comprising:
(d) dewatering the froth flotation tails by subjecting the froth flotation tails to liquid solids separation to yield a solids product for reclamation.

4. The process as claimed in claim 1, wherein the clay surface reagent is a cationic collector selected from the group consisting of dodecylamine (DDA), docecylamine hydrochloride (DDAHCl), docecyl-trimethylammonium chloride (DTAC) and cetyl-trimethylammonium bromide (CTAB).

5. The process as claimed in claim 1, further comprising pre-treating the tailings with a flocculant, a coagulant or both selective for clay minerals prior to treatment with the clay surface reagent.

6. The process as claimed in claim 5, wherein the flocculant is an anionic polyacylamide.

7. The process as claimed in claim 5, wherein the coagulant is polyaluminum chloride.

8. The process as claimed in claim 3, wherein the froth flotation tails are treated with a flocculant, a coagulant or both prior to liquid solids separation to yield the solids product.

9. The process as claimed in claim 3, wherein the liquid solids separation takes place in a gravity separator, a thickener, a centrifuge or a settling basin.

10. The process as claimed in claim 1, wherein the tailings is a fluid fine tailings.

11. The process as claimed in claim 10, wherein the fluid fine tailings are present in a tailings pond and the clay surface reagent is added to the fluid fine tailings in situ.

12. The process as claimed in claim 1, wherein the tailings are fine tailings produced during bitumen extraction of oil sands.

13. The process as claimed in claim 1, wherein the tailings are further treated with a frothing agent prior to froth flotation.

14. The process as claimed in claim 1, wherein the tailings are further treated with a depressant such as sodium silicate to depress the flotation of silts.
